(19) United States
(12) Patent Application Publication
(10) Pub. No.: US 2024/0118718 A1
(43) Pub. Date: Apr. 11, 2024

(54) PRESSURE-REDUCING VALVE

(71) Applicant: Neoperl GmbH, Müllheim (DE)

(72) Inventors: Martin FANGMEIER, Auggen (DE); Matthias HAUTH, Todtnau/Muggenbrunn (DE); Burkhard MEYER, Buggingen (DE)

(73) Assignee: Neoperl GmbH, Müllheim (DE)

(21) Appl. No.: 18/273,383

(22) PCT Filed: Feb. 21, 2022
(86) PCT No.: PCT/EP2022/054247

§ 371 Date: Jul. 20, 2023

(30) Foreign Application Priority Data
Mar. 17, 2021 (DE) 20 2021 101 348.6

(51) Int. Cl. G05D 16/10

(52) U.S. Cl. CPC G05D 16/103

(57) ABSTRACT

A pressure-reducing valve including a valve support with at least one through-flow channel, and a pot-shaped valve body which is displaceably guided against a restoring force from an open position into a closed position at a guide journal which protrudes into the pot-shaped interior of the valve body. In the closed position, the valve body rests via a peripheral edge of its pot shape against a valve seat provided on the valve support, so that the valve body closes at least one channel opening of the at least one through-flow channel. At least one wiper lip protrudes at the inner circumference of the pot of the valve body and/or at the outer circumference of the guide journal, and the wiper lip moves close to or rests against the outer circumference of the journal or the inner circumference of the pot of the adjacent component.

### CROSS-REFERENCE TO RELATED APPLICATIONS

This application is the U.S. National Phase of PCT Appln. No. PCT/EP2022/054247, filed Feb. 21, 2022, which claims priority from German Patent Application No. 10 2021 101 348.6, filed Mar. 17, 2021, the entire disclosures of which are incorporated by reference herein.

### TECHNICAL FIELD

The invention relates to a pressure-reducing valve comprising a valve support with at least one through-flow channel, and comprising a pot-shaped valve body which is displaceably guided from an open position counter to a restoring force into a closed position at a guide journal protruding into the pot-shaped interior of the valve body. In the closed position, the valve body rests via the peripheral edge of its pot shape against a valve seat provided on the valve support so that the valve body blocks at least one channel opening of the at least one through-flow channel.

### BACKGROUND

A pressure-reducing valve is already known from DE 10 2014 005 854 A1, which comprises a valve housing in the form of a sleeve-shaped mounting adapter. The valve housing of the known pressure-reducing valve has an internal thread on its first end-face region on the inflow side and an external thread on its second end-face region on the outflow side. Whereas the internal thread provided on the first end region on the inflow side can be screwed, for example, on a corner valve, the external thread provided on the second end-face region of the valve housing on the outflow side is screwable into the internal thread of a hose sleeve nut fitting of a flexible hose line, which leads to a water removal point or another water consumer.

The known pressure-reducing valve comprises, in the interior space of its valve housing, a valve support with at least one through-flow channel, and comprises a pot-shaped valve body which is displaceably guided from an open position counter to a restoring force into a closed position at a guide journal protruding into the pot-shaped interior of the valve body. In the closed position, the valve body rests via the peripheral edge of its pot shape against a valve seat provided on the valve support so that the valve body blocks at least one channel opening of the at least one through-flow channel. The interior space of the pot of the pot-shaped valve body forms a pressure compensation volume which is connected to the atmosphere, so that the valve body is displaced counter to the restoring force of at least one restoring element on the guide journal depending on the water pressure present on the outflow side of the pressure-reducing valve, wherein the opening cross-section of the at least one channel opening is changed or, if necessary, also completely closed.

In many regions, however, there is the problem that grains of sand or other contaminants can also be carried along with the water flow guided in the supply lines, which become stuck between the pot-shaped valve body and the guide journal and can damage the annular seal provided between these components.

### SUMMARY

The objective to be addressed is therefore providing a pressure-reducing valve of the aforementioned type, which can also be operated in such regions with little maintenance and without malfunctions, even when grains of sand or other smaller contaminants there enter the interior of the pressure-reducing valve via the supply lines.

This objective is achieved according to the invention with respect to the pressure-reducing valve of the aforementioned type more particularly by at least one wiper lip protruding from the inner pot circumference of the valve body and/or from the outer circumference of the guide journal, the wiper lip having been moved close to or resting against the outer circumference of the journal or the inner pot circumference of the adjacent component.

The pressure-reducing valve according to the invention comprises a valve support with at least one through-flow channel, and comprises a pot-shaped valve body which is displaceably guided from an open position counter to a restoring force into a closed position at a guide journal protruding into the pot-shaped interior of the valve body. The valve body, which is displaceably guided on the guide journal of the valve support and is pot-shaped, is displaceable on the guide journal depending on the water pressure present on the outflow side of the pressure-reducing valve counter to the restoring force of at least one restoring element so that the opening cross-section of the at least one channel opening is changed or, if necessary, also completely closed. In the closed position also of the pressure-reducing valve according to the invention, the valve body rests via the peripheral edge of its pot shape against a valve seat provided on the valve support so that the valve body blocks at least one channel opening of the at least one through-flow channel. In order to ensure that the grains of sand and other smaller contaminants carried along in the water flowing into the pressure-reducing valve cannot enter the annular gap between the guide journal and the valve body and damage an annular seal that may be provided in this annular gap, at least one wiper lip protrudes from the inner pot circumference of the valve body and/or from the outer circumference of the guide journal, the wiper lip having been moved close to or resting against the outer circumference of the journal or the inner pot circumference of the adjacent component (valve body or guide journal). Since the wiper lip protruding from the one component has been moved close to or rests against the adjacent component via its free lip edge, the annular gap remaining between the pot-shaped valve body and the guide journal is effectively protected against undesirable penetration by grains of sand and other smaller contaminants so that the pressure-reducing valve according to the invention is distinguished by low-maintenance and trouble-free operation.

In order to ensure that the annular gap remaining between the pot-shaped valve body and the guide journal is protected against contaminants as effectively as possible over the entire circumference, one preferred embodiment according to the invention provides that at least one wiper lip or at least one of the wiper lips preferably encircles the outer circumference of the guide journal and/or the inner pot circumference of the valve body in a cross-sectional plane.

A particularly simple and easily manufacturable embodiment according to the invention provides that the at least one wiper lip is integrally formed on the guide journal and/or on the valve body.

In order to also ensure that a wiper lip, which is integrally formed on the valve body and/or the guide journal and rests against the adjacent component (guide journal or valve body), does not impede the sliding motion of the valve body on the guide journal, it is advantageous when the at least one wiper lip or at least one of the wiper lips has a cross-sectional shape which tapers toward the free edge of the lip and preferably has the shape of an arrow tip.

Trouble-free operation of the pressure-reducing valve according to the invention is additionally supported when at least two wiper lips, which are spaced apart from each other in the longitudinal direction of the valve body or of the guide journal, are provided on the inner pot circumference of the valve body and/or on the outer circumference of the guide journal.

In order to protect the annular gap between the inner pot circumference of the valve body and the outer circumference of the guide journal against malfunction-inducing contaminants as well as possible over its entire longitudinal extension, it is advantageous when a first wiper lip of the at least two wiper lips protruding from the guide journal bounds the valve seat via the base of its cross-sectional shape.

One preferred embodiment according to the invention provides that the pressure-reducing valve has a valve housing, in the interior space of which the valve support is provided or inserted.

One preferred exemplary embodiment according to the invention provides that the valve housing is formed as a hose sleeve nut of a flexible hose line or as a sleeve-shaped mounting adapter of a line coupling.

### BRIEF DESCRIPTION OF THE DRAWINGS

Developments according to the invention are obvious from the following description of a preferred exemplary embodiment in connection with the claims and the drawing. The invention is described in greater detail below on the basis of a preferred exemplary embodiment, wherein:

FIG. 1 shows an isometric representation of a pressure-reducing valve which has a valve support from which a guide journal of the valve support protrudes, wherein a pot-shaped valve body is displaceably guided on the guide journal of the valve support from the open position shown here counter to a restoring force into a closed position, in which closed position the valve body rests against a valve seat of the valve support,

FIG. 2 shows an exploded component view of the pressure-reducing valve from FIG. 1, wherein, in this component view presented as an exploded view, the pot-shaped valve body, a restoring element acting as a restoring force and formed as a helical compression spring, an annular seal retained at the guide journal, the valve support with the guide journal protruding therefrom, and an annular seal of the pressure-reducing valve, which interacts with a valve housing (not shown here), are apparent,

FIG. 3 shows the pressure-reducing valve from FIG. 1 in a longitudinal section in the shape of a cut cake in the open position of the pressure-reducing valve,

FIG. 4 shows the pressure-reducing valve from FIGS. 1 through 3 in a central position of the valve body which is displaceably guided on the guide journal of the valve support,

FIG. 5 shows a longitudinal section of the pressure-reducing valve from FIGS. 1 through 4 in its closed position, in which closed position the pot-shaped valve body rests closely against a valve seat on the valve support,

FIG. 6 shows a detailed longitudinal section through the portion of the pressure-reducing valve circled in FIG. 5,

FIG. 7 shows an isometric representation of the valve support of the pressure-reducing valve shown in FIGS. 1 through 6, and

FIG. 8 shows a longitudinally cut side view of the pressure-reducing valve from FIGS. 1 through 6, wherein the pot-shaped valve body is in a central position in relation to the guide journal of the pressure-reducing valve.

### DETAILED DESCRIPTION

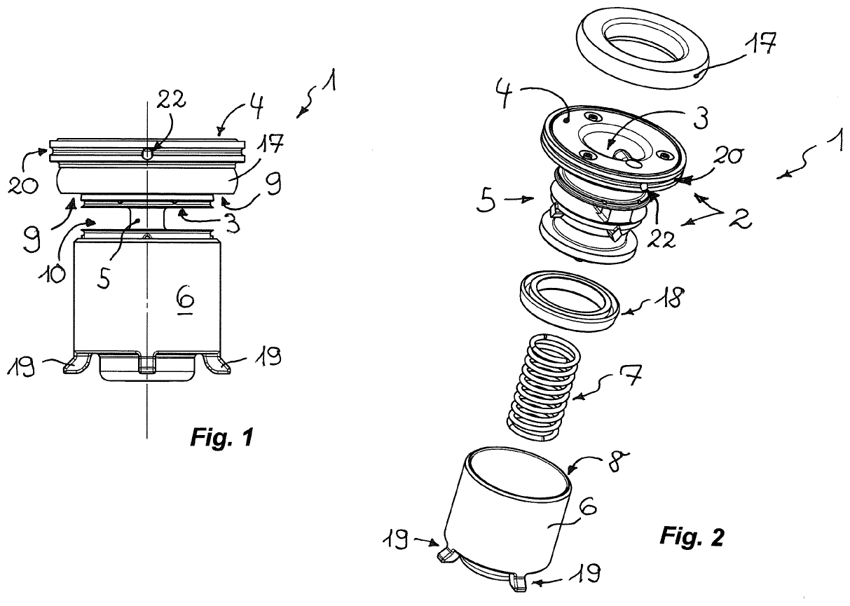

FIGS. 1 through 6 and 8 show a pressure-reducing valve 1, which is connected into a water line and through which a fluid flows in arrow direction PF 1. The pressure-reducing valve 1, through which a fluid flows in arrow direction PF1, is insertable, for example, into a water line in order to limit the water pressure in the line section downstream from the pressure-reducing valve 1 to an established maximum value. The pressure-reducing valve 1 comprises a valve support 2 in which at least one through-flow channel 3 is provided. The valve support 2 has a plate-shaped valve support section 4 which is arranged on the inflow side and from which a guide journal 5 protrudes. A pot-shaped valve body 6 is displaceably guided at the guide journal 5. If the line cross-section narrows in the region of the line section downstream from the pressure-reducing valve 1, for example, because a control and/or shut-off valve provided on the outflow side is only slightly open or is completely closed, and the water pressure continuously increases there, the displaceably guided valve body 6 moves under the pressure of the medium flowing therethrough from the open positions shown in FIGS. 1, 3, 4 and 8 counter to the restoring force of at least one compression or restoring spring 7 acting as a restoring element into the closed position shown in FIG. 5, in which closed position the valve body 6 rests, via the peripheral edge 8 of its pot shape, against a valve seat 9 provided at the valve support 2 so that the valve body 6 blocks at least one channel opening 10 of the at least one through-flow channel 3. Since, as water pressure rises in the line section situated downstream from the pressure-reducing valve 1, the valve body 6 is increasingly pressed toward the valve seat 9 of the valve support 2 counter to the restoring force of the at least one restoring spring 7 and, therefore, the pressure loss increases at the channel opening 10, which is therefore becoming smaller, the pressure of the fluid in the line section situated downstream from the pressure-reducing valve 1 is limited to an established maximum value.

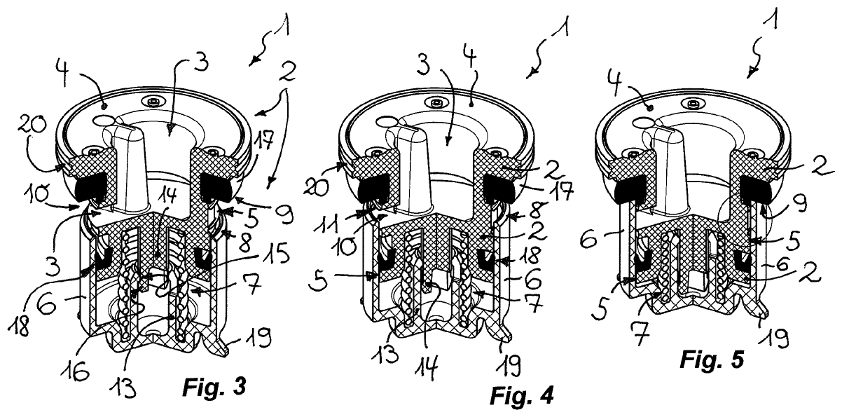

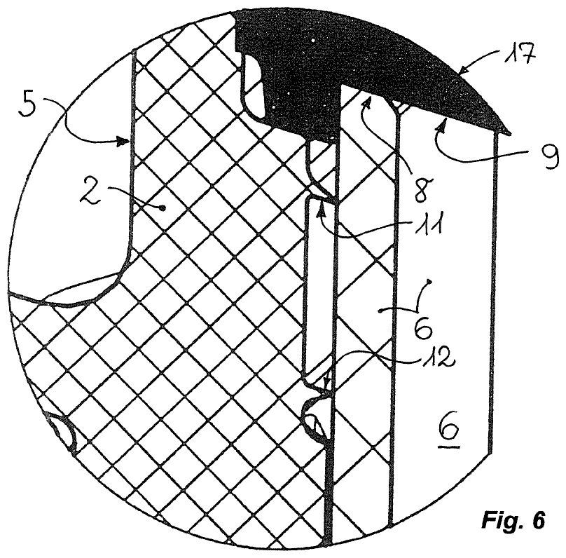

As is apparent in the longitudinal sections according to FIGS. 3 through 5 and 8 and, more particularly, in the detailed longitudinal section according to FIG. 6, at least one wiper lip 11, 12 protrudes from the inner pot circumference of the valve body and/or—as is the case here—from the outer circumference of the guide journal 5, the wiper lip 11, 12 having been moved close to or resting against the outer circumference of the journal or, in this case, the inner pot circumference of the adjacent component 6.

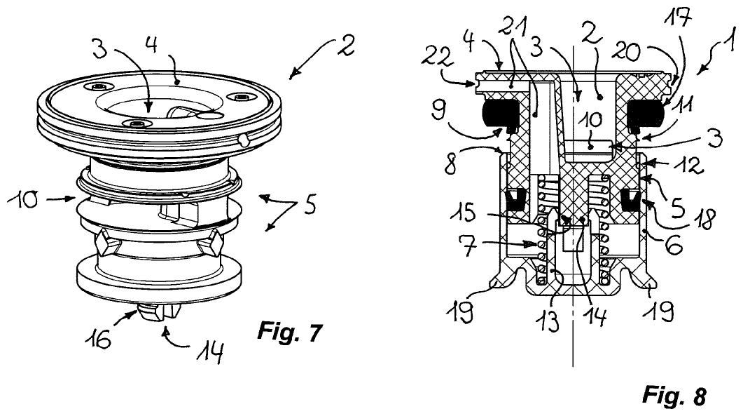

In the exemplary embodiment shown in FIGS. 1 through 8, two wiper lips 11, 12, which are spaced apart from each other, are provided on the outer circumference of the guide journal 5, encircle the outer circumference of the guide journal 5 in a cross-sectional plane, and are integrally formed on the guide journal 5. Due to the one-piece design of the guide journal 5 and its wiper lips 11, 12, the manufacture of this component 5 is substantially simplified. Since these wiper lips 11, 12 have moved close to or rest against the adjacent component 6, these wiper lips 11, 12 can effectively wipe off any grains of sand or similar dirt particles which could otherwise damage the annular seal 18 provided at the guide journal 5 and cause leaks in this region. The wiper lips 11, 12 protruding from the guide journal 5 each have a cross-sectional shape which tapers toward the free edge of the lip and, in this case, are in the shape of an arrow tip, wherein these wiper lips 11, 12 linearly rest against the inner pot circumference of the pot-shaped valve body 6 via the arrow tip of their cross-sectional shape. Since the wiper lips 11, 12 therefore taper toward their free peripheral edge, and since the peripheral edge of these wiper lips is comparatively sharp, the manufacture of the guide journal 5 and the wiper lips integrally formed thereon is substantially simplified, and the wiper lips 11, 12 can elastically easily evade some of these dirt particles if some of these dirt particles were in fact to inadvertently enter the region of these wiper lips 11, 12 or slightly cut into these wiper lips 11, 12. Of the two wiper lips 11, 12 protruding from the guide journal 5, a first wiper lip 11 bounds the valve seat 9 on the valve support 2 via the base of its cross-sectional shape.

By means of the wiper lips 11, 12, which protrude from the guide journal 5 and rest against the inner pot circumference of the valve body 6 in this case, the annular gap remaining between the valve body 6 and the guide journal 5 is protected against a malfunction-inducing penetration of grains of sand or similar contaminants carried along in the water flow. Since the first wiper lip 11 bounds the valve seat 9 via the base of its cross-sectional shape, the annular gap between the valve body 6 and the guide journal 5 is protected against malfunction-inducing contaminants practically over its entire longitudinal extension. Since the wiper lips 11, 12 only linearly rest against the inner pot circumference of the valve body 6 via their free edge, the frictional resistance caused by the wiper lips 11, 12 is kept sufficiently low and a displacement of the valve body 6 at the guide journal 5 of the valve support 2 is not further impaired.

In FIG. 6, it is indicated that the sides of the arrow-tip-shaped wiper lips 11, 12 are pitched more steeply on the side facing the water outlet in comparison to the opposite side. As a result, the desired acute angle of the arrow-tip-shaped wiper lips 11, 12 and, simultaneously, the steep increase on the side facing the water inlet of the pressure-reducing valve 1 is achieved, as the result of which grains of sand can be particularly well wiped off the inner pot circumference of the valve body 6.

The pressure-reducing valve 1 has a valve housing (not shown in further detail here), in the interior space of which the valve support 2 has been inserted with the valve body 6, which is displaceably guided at its guide journal 5. The valve housing can be in the form of a hose sleeve nut of a flexible hose line or a sleeve-shaped mounting adapter of a line coupling.

In the longitudinal sections according to FIGS. 3 through 5 and 8, it is apparent that a central retaining sleeve 13 is provided at the pot base of the valve body 6 on the inside of the end face, wherein a retaining journal 14 arranged on the guide journal 5 of the valve support 2 protrudes into the retaining sleeve 13. A stop 15 is provided on the inner circumference of the retaining sleeve 13, which interacts with a counter-stop 16 on the outer circumference of the retaining journal 14 so that, in the open position of the pressure-reducing valve 1, the stop 15 and the counter-stop 16 limit the displacement travel of the valve body 6 in relation to the guide journal 5 of the valve support 2. Since the stop 15 and the counter-stop 16 interacting therewith limit the displacement travel of the valve body 6, it is ensured that the pressure-reducing valve 1 represented here does not unintentionally fall apart during storage, transport or assembly. The valve support 2, the valve body 6 and the restoring spring 7, which acts between these, in addition to the associated annular seals 17, 18, practically form an insert unit or insert cartridge which only needs to be inserted into the valve housing (not shown in greater detail here) in order to complete the pressure-reducing valve 1. As a result, the assembly of the pressure-reducing valve 1 shown here is substantially simplified.

In FIG. 2 it is apparent that the restoring element applying the restoring force is in the form of a helical compression spring 7 in this case. The helical compression spring 7 acting as a restoring element encompasses the retaining journal 14 and the retaining sleeve 13. The retaining journal 14 and the retaining sleeve 13 are aligned axially with respect to each other and to the longitudinal axis of the valve housing.

The plate-shaped valve support section 4 of the valve support 2 is immovably held in the interior of the valve housing (not shown in greater detail here) when the pressure-reducing valve 1 is in the working position. In order to ensure that the fluid flowing through the pressure-reducing valve 1 can only pass through the at least one through-flow channel 3, the annular seal 17, which also forms the valve seat 9 in this case, is provided on the plate-shaped valve support section 4. Due to the annular seal 17, this valve support section 4 can rest closely against the inner circumference of the valve housing. In the closed position shown in FIG. 5, the pot-shaped valve body 6 rests closely against the end face of the annular seal 17 facing away from the valve support section 4 via the front peripheral edge 8 of its pot shape. A further annular seal 18 is provided at the guide journal 5 of the valve support 2, the annular seal 18 sealing the pot-shaped interior of the pot-shaped valve body 6 with respect to the fluid which is flowing through. The annular seal 18 rests closely against the inner pot circumference of the valve body 6. On the outer circumference of the valve body 6, at least one slide element 19 and preferably more than two slide elements 19, which are spaced apart from each other more particularly uniformly in the circumferential direction, is/are provided, which protrudes(s) in the radial direction over the valve body 6 so that an annular channel is formed between the inner circumference of the valve housing (not shown here) and the outer circumference of the valve body 6. Since the valve body 6 slides on the inner circumference of the valve housing only via its laterally protruding slide elements 19, the friction surface of the valve body 6 is effectively reduced.

It becomes clear from the longitudinal section in FIG. 8 that an annular groove 20 is provided on the outer circumference of the plate-shaped valve support section 4. This annular groove 20 is connected to the pot-shaped interior space of the pot-shaped valve body 6 via at least one ventilation channel 21. At least one ventilation opening 22 is provided in the valve housing of the pressure-reducing valve 1, the which opens into the annular groove 20 on the valve support section 4. During the sliding motions of the valve body 5, the air captured in the pot-shaped interior space of the pot-shaped valve body 6 can escape via the ventilation channel 21 and the ventilation opening 22. In this way, it is ensured that an undesirable counter-pressure cannot build up in the pot-shaped interior space of the pot-shaped valve body 6 when the pressure of the fluid on the outlet side presses the valve body 6 onto the guide journal 5 of the valve support 2. By means of the pressure-reducing valve 1 located in the valve housing, the subsequent line section on the outflow side and/or a sanitary system connected to the pressure-reducing valve 1 via the line section on the outflow side can be protected against an exceedingly high pressure of the fluid and against pressure-induced bursting.

### LIST OF REFERENCE CHARACTERS

1 pressure-reducing valve
2 valve support
3 through-flow channel
4 valve support section
5 guide journal
6 valve body
7 restoring spring
8 peripheral edge
9 valve seat
10 channel opening
11 first wiper lip
12 second wiper lip
13 retaining sleeve
14 retaining journal
15 stop
16 counter-stop
17 annular seal
18 annular seal
19 slide element
20 annular groove
21 ventilation channel
22 ventilation opening
PF1 through-flow direction

1. A pressure-reducing valve (1), comprising:
a valve support (2) with at least one through-flow channel (3),
a pot-shaped valve body (6) displaceably guided from an open position counter to a restoring force into a closed position at a guide journal (5) protruding into a pot-shaped interior of the valve body (6), wherein in the closed position the valve body (6) rests via a peripheral edge (8) of said pot shape against a valve seat (9) provided on the valve support (2) so that the valve body (6) closes at least one channel opening (10) of the at least one through-flow channel (3);
at least one wiper lip (11, 12) protrudes from at least one of an inner circumference of the pot-shaped interior of the valve body (6) or an outer circumference of the guide journal (5), the wiper lip (11, 12) being in proximity to or resting against a facing one of the outer circumference of the journal or the inner circumference of the pot-shaped interior of the pot-shaped valve body or the guide journal (5; 6).

2. The pressure-reducing valve (1) as claimed in claim 1, wherein the at least one wiper lip (11, 12) or at least one of the wiper lips (11, 12) encircles at least one of the outer circumference of the guide journal (5) or the inner circumference of the pot-shaped interior of the valve body (6) in a cross-sectional plane.

3. The pressure-reducing valve (1) as claimed in claim 1, wherein the at least one wiper lip (11, 12) is integrally formed on at least one of the guide journal (5) or on the valve body (6).

4. The pressure-reducing valve (1) as claimed in claim 1, wherein the at least one wiper lip (11, 12) or at least one of the wiper lips (11, 12) has a cross-sectional shape which tapers toward a free edge of the lip.

5. The pressure-reducing valve (1) as claimed in claim 1, wherein the at least one wiper lip comprises at least two of the wiper lips (11, 12), which are spaced apart from each other in a longitudinal direction of the valve body (6) or of the guide journal (5).

6. The pressure-reducing valve (1) as claimed in claim 5, wherein a first wiper lip (11) of the at least two wiper lips (11, 12) protrudes from the guide journal (5) and at least one of bounds the valve seat (9) or rests directly against the valve seat (9) via a base of a cross-sectional shape of said first wiper lip.

7. The pressure-reducing valve (1) as claimed in claim 1, further comprising a valve housing having an interior space, and the valve support (2) is provided or inserted in the interior space.

8. The pressure-reducing valve (1) as claimed in claim 7, wherein the valve housing is formed as a hose sleeve nut of a flexible hose line or as a sleeve-shaped mounting adapter of a line coupling.

9. The pressure-reducing valve (1) as claimed in claim 4, wherein the free edge of the lip has an arrow tip shape.

10. The pressure-reducing valve (1) as claimed in claim 5, wherein the wiper lips are provided on the pot-shaped interior of the valve body (6).

11. The pressure-reducing valve (1) as claimed in claim 5, wherein the wiper lips are provided on the outer circumference of the guide journal (5).
